(19) United States
(12) Patent Application Publication
(10) Pub. No.: US 2002/0024717 A1
(43) Pub. Date: Feb. 28, 2002

(54) Multi-wavelength light source for use in optical communication and method of acquiring multi-wavelength lights

(75) Inventor: Keiji Nakamura, Tokyo (JP)

Correspondence Address: SUGHRUE, MION, ZINN, MACPEAK & SEAS, 2100 Pennsylvania Avenue, N.W., Washington, DC, 20037-3202, US

(73) Assignee: NEC CORPORATION

(21) Appl. No.: 09/895,271

(22) Filed: Jul. 2, 2001

(30) Foreign Application Priority Data
Jul. 4, 2000 (JP) 2000-202585

(51) Int. Cl. G02F 1/35

(52) U.S. Cl. 359/326

(57) ABSTRACT

A multi-wavelength light source having standard light sources, an optical fiber, to which standard lights emitted by the reference sources are supplied, generating a four-wave-mixing light from the supplied standard lights, and optical filters acquiring a plurality of lights having different frequencies from the four-wave-mixing light generated by the optical fiber. A part of the generated four-wave-mixing light is returned to the optical fiber as a fresh standard light.

### FIELD OF THE INVENTION

The present invention relates to a multi-wavelength light source that is capable of generating a plurality of lights having different frequencies, and a method of acquiring multi-wavelength lights.

### DESCRIPTION OF THE PRIOR ART

In recent years, in accordance with a large increase in the capacity of communication circuits, a so-called Dense Wavelength Division Multiplexing transmission system (it will hereinafter be referred to as DWDM transmission system) capable of transmitting a plurality of light signals having different frequencies has been put into practical use. With such DWDM transmission system, in order to make estimations and/or experiments of the system, a multi-wavelength light source, which is able to cover a broad range of wavelengths, is needed to estimate wavelength characteristics and the like of diverse optical devices constituting the system.

There exists hitherto no multi-wavelength light source able to generate a plurality of lights having different frequencies. Thus, until now, when estimations and/or experiments of the above communication system is carried out, a plurality of semiconductor lasers generating beams of different oscillation wavelengths have been used to estimate the wavelength characteristics and the like of the optical devices. However, in the technical method of employing the plurality of semiconductor lasers of different oscillation wavelengths for making estimations and/or experiments of a communication system, because a semiconductor laser must be prepared for each of the wavelengths must, it is disadvantageous in the aspect of the cost. Therefore, a multi-wavelength light source able to generate a plurality of lights having different frequencies has long been necessary requested.

Although it is true that acquisition of a plurality of lights having different frequencies from an output light of a broadband spectrum light source by using narrowband filters has already been proposed, the wavelengths of the lights acquired in this case are determined depending on the property of the used narrowband filters, and thus coherent lights cannot be acquired. Accordingly, such lights cannot be applied to making estimations and/or experiments of any communication system described above.

### SUMMARY OF THE INVENTION

A first object of the present invention is to provide an excellent, low cost and stable multi-wavelength light source, which is capable of solving the above-described problems encountered by the prior art, and is able to be used for making estimations and/or experiments of the above-described Dense Wavelength Division Multiplexing (DWDM) transmission system.

A second object of the present invention is to provide a method of acquiring multi-wavelength lights, by which method such multi-wavelength light source can be realized.

In order to achieve the first object, a multi-wavelength light source according to the present invention includes a standard light generating means for generating a plurality of standard lights having frequencies separate from one another by a predetermined frequency difference, a four-wave-mixing means, to which the plurality of standard lights generated by the standard light generating means are supplied, for generating a four-wave-mixing light from the supplied standard lights, and an optical filter means for acquiring a plurality of lights of different frequencies from the four-wave-mixing light generated by the optical four wave mixing means, the above-mentioned four-wave-mixing means being arranged so that a part of the generated four-wave-mixing light is supplied as a fresh standard light, together with the plurality of standard lights supplied by the afore-mentioned standard light generating means to generate the four-wave-mixing light.

In the above-described case, the four-wave-mixing means includes a first optical fiber having a zero-dispersion wavelength close to the frequencies of the plurality of standard lights supplied by the afore-mentioned standard light generating means. Furthermore, in this case, the afore-mentioned four-wave-mixing means may further include a second optical fiber having a zero-dispersion wavelength, which is shifted from the zero-dispersion wavelength of the first optical fiber toward either a longer wavelength side or a shorter wavelength side. Also, the afore-mentioned standard light generating means may be constituted by a plurality of lasers of different wavelengths.

In order to achieve the above-mentioned second object, the multi-wavelength light acquiring method according to the present invention includes: launching a plurality of standard lights having separate frequencies different from one another by a predetermined frequency difference into a predetermined optical fiber to thereby generate a four-wave-mixing light, launching again a part of the four-wave-mixing light into the above-described predetermined optical fiber as a fresh standard light, repeating the process of generating the four-wave-mixing light from the fresh standard light and the afore-mentioned plurality of standard lights, and acquiring a plurality of lights of different frequencies from the four-wave-mixing light generated during the repetition of the generating process of the four-wave-mixing light.

In the above-mentioned case, the plurality of standard lights may be constituted by coherent lights. Further, the predetermined optical fiber may be constituted by a plurality of optical fibers constituted by a first optical fiber of a predetermined zero-dispersion wavelength and a second optical fiber having a zero-dispersion wavelength, which is shifted from the zero-dispersion wavelength of the first optical fiber toward either a longer wavelength side or a shorter wavelength side.

It should be understood that in the above-described present invention, the four-wave-mixing phenomenon is one of the nonlinear optical effects that is utilized. Namely, according to the present invention, a plurality of standard lights of separate frequencies different from one another by a predetermined frequency difference are subjected to the four-wave-mixing process to generate a four-wave-mixing light containing therein a fresh lightwave. Further, a part of the generated four-wave-mixing light is used as a fresh standard light to generate the four-wave-mixing light. Thus, the four-wave-mixing light that is generated by repeating the process of four-wave-mixing plural times contains a plurality of lightwaves of different frequencies separate from one another by a predetermined frequency difference. Accordingly, when each lightwave of four-wave-mixing light is taken out, it is possible to acquire a plurality of lights having different frequencies. When coherent lights are used as the above described standard lights, a plurality of coherent lights having different frequencies can be acquired from the four-wave-mixing light.

Furthermore, in the present invention, since the first optical fiber having a zero-dispersion wavelength close to the frequencies of the standard lights is employed, generation of the four-wave-mixing light can be carried out at a high efficiency, while enabling it to generate a stable four-wave-mixing light.

During the repetition of the process of four-wave-mixing to acquire a fresh standard light, if the acquired fresh standard light has a frequency shifted away from those of the original standard lights, generation of the four-wave-mixing light from such acquired fresh standard light cannot be effectively achieved by the first optical fiber. Thus, with the present invention, when it employs the second optical fiber having a zero-dispersion wavelength, which is shifted away from that of the first optical fiber toward either a longer wavelength side or a shorter wavelength side, the above-mentioned fresh standard light having a frequency shifted away from those of the original standard lights can be effectively subjected to the process of four-wave-mixing by the second optical fiber, and therefore a stable four-wave-mixing light can be generated.

The above and other objects, features, and advantages of the present invention will become apparent from the following description with reference to the accompanying drawings, which illustrate examples of preferred embodiments of the present invention.

### BRIEF DESCRIPTION OF THE DRAWINGS

FIG. 1 is a block diagram illustrating a schematic construction of a multi-wavelength light source according to an embodiment of the present invention;

FIG. 2 is a diagrammatic view illustrating a four-wave-mixing process of two standard lights f₁ and f₂;

FIG. 3a is a diagrammatic view illustrating four standard lights having frequencies f₁ to f₄;

FIG. 3b is a diagrammatic view illustrating four-wave-mixing of two standard lights having frequencies f₁ and f₂;

FIG. 3c is a diagrammatic view illustrating four-wave-mixing of two standard lights having frequencies f₂ and f₃;

FIG. 3d is a diagrammatic view illustrating four-wave-mixing of two standard lights having frequencies f₃ and f₄;

FIG. 3e is a diagrammatic view illustrating four-wave-mixing of two standard lights having frequencies f₁ and f₃;

FIG. 3f is a diagrammatic view illustrating four-wave-mixing of two standard lights having frequencies f₁ and f₄;

FIG. 3g is a diagrammatic view illustrating four-wave-mixing of two standard lights having frequencies f₂ and f₄;

FIG. 3h is a diagrammatic view illustrating four-wave-mixing of four standard lights having frequencies f₁ to f₄;

FIG. 4 is a block diagram illustrating a schematic construction of a multi-wavelength light source according to another embodiment of the present invention.

### DESCRIPTION OF THE PREFERRED EMBODIMENTS

The description of the embodiments of the present invention will be provided hereinbelow with reference to the accompanying drawings.

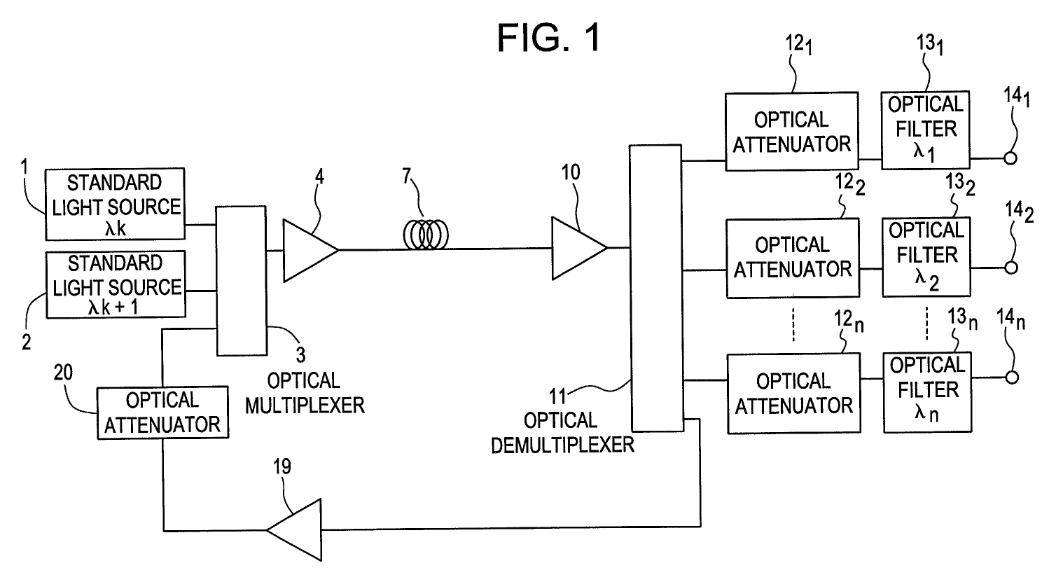

FIG. 1 illustrates the schematic construction of a multi-wavelength light source according to an embodiment of the present invention. The multi-wavelength light source is constituted by a standard light source 1 of wavelength λ_{k,} a standard light source 2 of wavelength λₖ₊₁, an optical multiplexer 3, optical amplifiers (OPT/AMPs) 4, 10 and 19, an optical fiber 7, an optical demultiplexer 11, optical attenuators (OPT/ATT) 12, to 12. and 20, optical filters 13₁, to 13ₙ, and optical outputs 14₁ to 14ₙ.

The standard light sources 1 and 2 are formed by lasers, for example, semiconductor lasers. The wavelength difference between these standard light sources 1 and 2 can be considered as being Δf−λₖ₊₁−λ_{k·}It should be understood that, although the two standard light sources are used in this example of the present embodiment, three or more light sources of different wavelengths might alternatively be used.

The optical multiplexer 3 to which the lights from the standard light sources 1 and 2 and a part of the light optically branched by the optical demultiplexer 11 are supplied as the incident light mixes these incident lights so as to conduct the optical multiplexing (the wavelength multiplexing of the lights). The lights subjected to the optical multiplexing by the optical multiplexer 3 are optically amplified by the optical amplifier 4, and then enter the optical fiber 7.

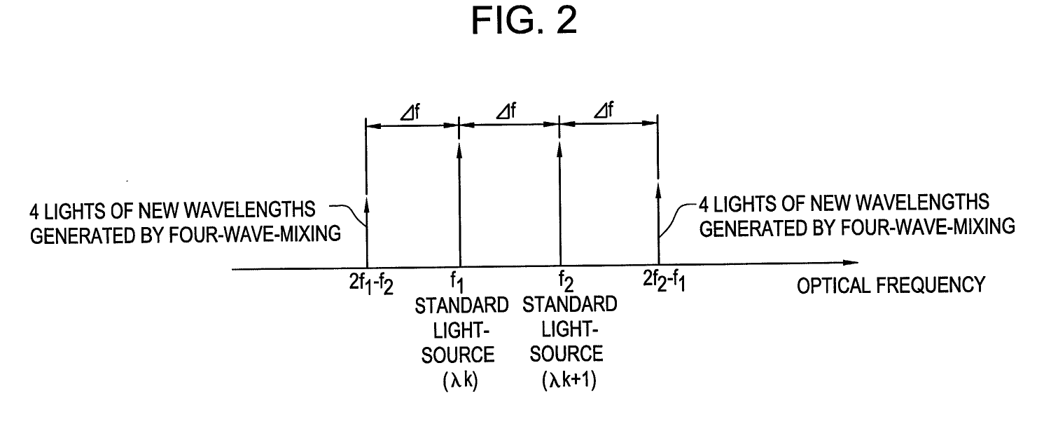

The optical fiber 7 whose zero-dispersion wavelength is close to the wavelengths λₖ and λₖ₊₁ generates a four-wave-mixing light arranged at a wavelength difference that is the same as the wavelength difference Δf of the standard light sources 1 and 2 due to the four-wave-mixing that is one of the nonlinear optical effects, when the incident lights optically amplified by the optical amplifier 4 enter therein. The way of generating the four-wave-mixing light is diagrammatically shown in FIG. 2.

In the illustrated example of FIG. 2, the frequencies of the lights supplied by the standard light sources 1 and 2 are identified by f₁ and f₂. When the two high level lights of frequencies f₁ and f₂ close to each other are propagated into the optical fiber 7, two new lights having new frequencies 2f₁-f₂ and 2f₂-f₁ are additionally generated by the nonlinear optical effect of the optical fiber 7. Namely, in this case, four-wave-mixing lights 2f₁-f₂, f₁, f₂ and 2f₂-f₁ are generated. If the zero-dispersion wavelength of the optical fiber 7 is close to the frequencies f₁ and f₂ of the lights supplied by the standard light sources 1 and 2, the efficiency of generation of the four-wave-mixing lights is enhanced. For example, in the multi-wavelength light sources having a band of 1,550 nanometers (nm), a dispersion Shifted Fiber (DSF) should desirably be used as the optical fiber 7.

The optical amplifier 10 optically amplifies the four-wave-mixing lights generated by the optical fiber 7. The optical demultiplexer 11 optically branches the amplified four-wave-mixing lights from the optical amplifier 10 for each frequency so as to conduct optical demultiplexing. A part of the optically branched lights subjected to the optical demultiplexing by the optical demultiplexer 11 is returned to the optical multiplexer 3 as a fresh standard light, via the optical amplifier 19 and the optical attenuator 20. The other part of the optically branched lights subjected to the optical demultiplexing by the optical demultiplexer 11 are supplied to the optical attenuators 12₁ to 12ₙ. the supplied lights are optically attenuated to a suitable optical level by each of the optical attenuators 12₁ to 12ₙ.

The lights optically attenuated by the respective optical attenuators 12₁ to 12ₙ are severally passed through the respective optical filters 13₁ to 13ₙ, and then the passed lights are severally provided from the respective optical outputs 14₁ to 14ₙ to the outside of the multi-wavelength light source as output lights. The respective optical filters 13₁ to 13ₙ whose transmission wavelengths are different from each other pass the wavelength of each of the four-wave-mixing lights supplied by the optical fibers 7.

The operation of the above-described multi-wavelength light source will be specifically provided hereinbelow.

The standard lights λₖ and λₖ₊₁ having wavelength (frequency) difference Δf that are supplied by the respective light sources 1 and 2 are mixed by the optical multiplexer 3, and are subsequently optically amplified to a higher level of output lights by the optical amplifier 4. Thereafter, the output lights of the optical amplifier 4 are supplied to the optical fiber 7. When the standard lights coming from the respective standard light sources 1 and 2 are supplied to the optical fiber 7, two new light waves having respective new wavelengths are generated therein due to the effect of four-wave-mixing. Therefore, four-wave-mixing lights consisting of a total four light waves of the frequency difference Δf (the same frequency difference as that of the standard lights) are supplied by the optical fiber 7.

The four-wave-mixing lights supplied by the optical fiber 7 are optically amplified by the optical amplifier 10 and are subsequently subjected to being optically branched by the optical demultiplexer 11. The branched lights pass the optical filters 13₁ to 13ₙ via the optical attenuators 12₁ to 12ₙ, so that a plurality of lights of different wavelengths is eventually acquired. A part of the branched light optically branched by the optical demultiplexer 11 is optically amplified by the optical amplifier 20 and is then optically attenuated by the optical attenuator 20 to a predetermined level to enter to the optical multiplexer 3. Thus, in the optical multiplexer 3, the optically branched light returned from the optical demultiplexer 11 and the standard lights λₖ, λₖ₊₁ of frequency (wavelength) difference Δf emitted by the respective standard light sources 1 and 2 are optically mixed therein. The light optically mixed by the optical multiplexer 3 is again optically amplified by the optical amplifier 4 and is then allowed to enter the optical fiber 7. Therefore, in the optical fiber 7, six fresh lightwaves of new wavelengths are generated due to the four-wave-mixing effect. Thus, the four-wave-mixing lights consisting of a total of ten lightwaves of frequency difference Δf (the wavelength difference of the standard light sources) are acquired.

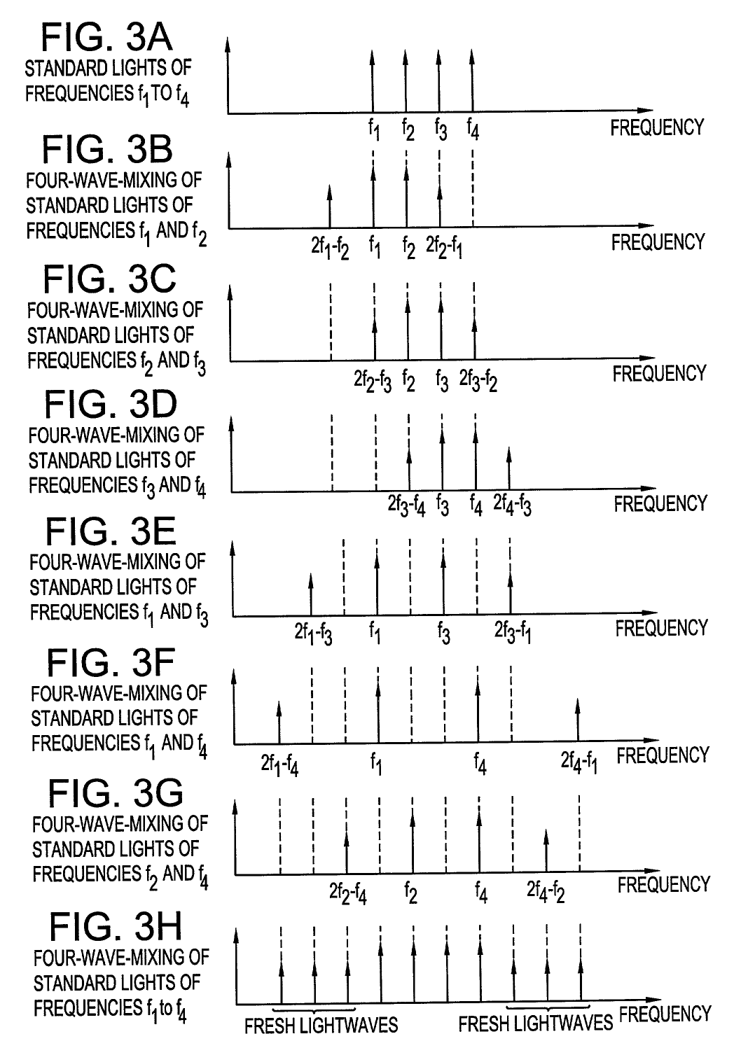

FIGS. 3a to 3h diagrammatically illustrate the four-wave-mixing based on the four standard lights. In this example, as shown in FIG. 3a, the respective standard lights of respective frequencies f₁, f₂, f₃, and f₄ are separated away from one another by a predetermined frequency difference. The four-wave-mixing is effected between respective two of the standard lights f₁ to f₄. That is to say, the four-wave-mixing lights including four lightwaves (2f₁-f₂, f₁, f₂, 2f₂-f₁) are generated between the two standard lights of f₁ and f₂ (refer to FIG. 3b), and the four-wave-mixing lights including four lightwaves (2f₂-f₃, f₂, f₃, 2f₃-f₂) are generated between the two standard lights of f₂ and f₃ (refer to FIG. 3c). Further, the four-wave-mixing lights including four lightwaves (2f₃-f₄, f₃, f₄, 2f₄-f₃) are generated between the two standard lights of f₃ and f₄ (refer to FIG. 3d), and the four-wave-mixing lights including four lightwaves (2f₁-f₃, f₁, f₃, 2f₃-f₁) are generated between the two standard lights of f₁ and f₃ (refer to FIG. 3e). Furthermore, the four-wave-mixing lights including four lightwaves (2f₁-f₄, f₁, f₄, 2f₄-f₁) are generated between the two standard lights of f₁ and f₄ (refer to FIG. 3f), and the four-wave-mixing lights including four lightwaves (2f2-f₄, f₂, f₄, 2f₄-f₂) are generated between the two standard lights of f₂ and f₄ (refer to FIG. 3g). Due to these four-wave-mixings, the six fresh lightwaves of new wavelengths are generated, and accordingly, the four-wave-mixing lights consisting of ten lightwaves with an equal difference in frequency are acquired as shown in FIG. 3h.

As described hereinbefore, in the present embodiment, a specified process is repeated so that a part of the four-wave-mixing lights generated by the optical fiber 7 is returned as a fresh standard light, which is allowed to re-enter the optical fiber 7 to thereby be again subjected to the four-wave-mixing, and as a result, a plurality of lights separated away from one another by an equal frequency difference and having different wavelengths can be acquired.

Another Embodiment

In the afore-described embodiment, during the repeating process of four-wave-mixing in the optical fiber 7, when the number of standard lights employed is increased, the wavelength of a part of the standard lights might be shifted off the range of the zero-dispersion wavelength of the optical fiber 7. More specifically, the shifting of the wavelength occurs from the zero-dispersion wavelength range toward a shorter wavelength side and a longer wavelength side. These lights that are shifted from the zero-dispersion wavelength range causes reduction in the efficiency of generation of four-wave-mixing lights in the optical fiber 7. The reduction in the efficiency of generation of four-wave-mixing lights can be overcome by employing a plurality of optical fibers whose zero-dispersion wavelengths are appropriately shifted. Thus, a description of the plurality of optical fibers of which the zero-dispersion wavelengths are shifted is provided below.

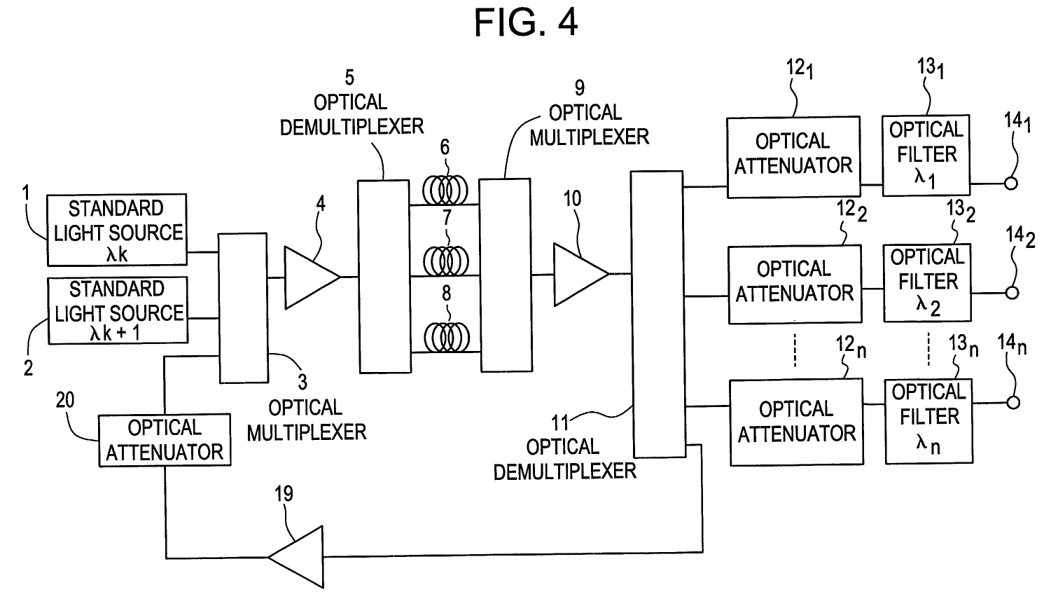

FIG. 4 is a block diagram illustrating a multi-wavelength light source according to another embodiment of the present invention. The illustrated multi-wavelength light source has such a construction that an optical branching filter or optical demultiplexer 5, optical fibers 6 and 8, and an optical multiplexer 9 are newly added to the construction of the above-described multi-wavelength light source of FIG. 1. Therefore, the same elements as those shown in FIG. 1 are designated in FIG. 4 by the same reference numerals, and any detailed description of these elements will be omitted hereinbelow for brevity's sake.

The optical fiber 6 is formed so that the zero-dispersion wavelength thereof is shifted toward a longer wavelength side with respect to that of the optical fiber 7. The optical fiber 8 is formed so that the zero-dispersion wavelength thereof is shifted toward a shorter wavelength side with respect to that of the optical fiber 7. The optical demultiplexer 5 optically branches the light optically amplified by the optical amplifier 4. The lights optically branched by the optical demultiplexer 5 are respectively entered to the optical fibers 6 to 8. The optical multiplexer 9 optical mixes the four-wave-mixing lights generated by the optical fibers 6 to 8. The light optically mixed by the optical multiplexer 9 is optically amplified by the optical amplifier 10, and then the amplified light is optically branched by the optical demultiplexer 11.

In the multi-wavelength light source of the present embodiment, the standard lights supplied by the standard light sources 1 and 2 are optically mixed by the optical multiplexer 3, and the resultant light is optically amplified by the optical amplifier 4. Then, the amplified light is optically branched by the optical branching filter 5, and the resultant branched lights are entered to the respective optical fibers 6 to 8. With the optical fibers 6 to 8, when the standard lights are entered, two fresh lightwaves having new wavelengths are generated by the four-wave-mixing effect. However, since the respective zero-dispersion wavelengths of the optical fibers 6 and 8 are shifted off the wavelengths of the standard lights, an efficiency of generation of four-wave-mixing light in the optical fibers 6 and 8 is kept low. On the other hand, as the zero-dispersion wavelength of the optical fiber 7 is set to be close to the wavelengths of the standard lights, the generation efficiency of the four-wave-mixing light in the optical fiber 7 is kept high. It should, therefore, be understood that the generation of the four-wave-mixing lights at this time of operation is mainly conducted by the optical fiber 7.

The four-wave-mixing lights generated by the optical fibers 6 to 8 are mixed by the optical multiplexer 9, and the optically mixed light is amplified by the optical amplifier 10. Thereafter, the amplified light is optically branched by the optical demultiplexer 11. A part of the optically branched lights is amplified by the optical amplifier 19 and is subsequently attenuated by the optical attenuator 20 to a predetermined optical level. Then, the attenuated light of predetermined optical level is returned to the optical multiplexer 3 to be optically mixed with the standard lights emitted by the standard light sources 1 and 2. The resultant light optically mixed by the optical multiplexer 3 is again optically amplified by the optical amplifier 4, and is then optically branched by the optical multiplexer 5 to enter to the respective optical fibers 6 to 8. Thus, the optical fibers 6 to 8 again generate fresh lightwaves having new wavelengths due to the four-wave-mixing process.

In the above-described repeating process of four-wave-mixing, the number of standard lights entering the respective optical fibers 6 to 8 is increased, the wavelength of a part of the standard lights is shifted off the range of the zero-dispersion wavelength of the optical fiber 7, i.e., the wavelength in question is shifted off the above-mentioned range toward a shorter wavelength side and a longer wavelength side. Such standard lights whose wavelengths are shifted off the range of the zero-dispersion wavelength causes a reduction in the efficiency of generation of the four-wave-mixing light in the optical fiber 7. The standard light whose wavelength is shifted off the range of the zero-dispersion wavelength of the optical fiber 7 toward the longer wavelength side can be effectively subjected to the four-wave-mixing process by the optical fiber 6. Further, the standard light of whose wavelength is shifted off the range of the zero dispersion wavelength of the optical fiber 7 toward the shorter wavelength side can be effectively subjected to the four-wave-mixing process by the optical fiber 8. As described above, in the present embodiment, a combination of the optical fibers 6 to 8 which have the shifted zero-dispersion wavelengths can contribute to an increase in the generation efficiency of four-wave-mixing light over a broader range of the optical wavelengths. As a result, the range of wavelength of the output lights from the optical outputs 14₁ to 14ₙ can be broadened.

In the above-described embodiment of FIG. 4, although three optical fibers 6 to 8 are employed, one or more additional optical fiber fibers having shifted zero-dispersion wavelengths may additionally be provided as required. In this case, the wavelength range of the output lights can be more broadened.

As described above, in accordance with the present invention, since a plurality of lights having different frequencies can be acquired from the two standard lights of a voluntary frequency difference Δf, the number of the standard light sources may be two. Accordingly, an effective cost reduction can be achieved in comparison with the prior art way in which a semiconductor laser must be provided for each of the different frequencies.

Further, in accordance with the present invention, if a coherent light is used as each of the standard lights, a plurality of coherent lights having different frequencies can be acquired. Accordingly, a multi-wavelength light source adapted for making estimations and/or experiments of a Dense Wavelength Division Multiplexing (DWDM) transmission system can be provided.

Furthermore, in accordance with the present invention, a stable four-wave-mixing light can be generated, and accordingly a multi-wavelength light source that is excellent in the stability in the operation thereof can be provided.

While preferred embodiments of the present invention have been described using specific terms, such description is for illustrative purposes only, and it is to be understood that changes and variations may be made without departing from the spirit and scope of the following claims.

What is claimed is:

1. A multi-wavelength light source comprising:
a standard light generating means for generating a plurality of standard lights of different frequencies, the difference between which is predetermined;
a four-wave-mixing means for generating a four-wave-mixing light from the incident standard lights including said standard lights generated by said standard light generating means; and
an optical filter means for acquiring a plurality of lights of different frequencies from said four-wave-mixing light generated by said four-wave-mixing means;
wherein said four-wave-mixing means is arranged so that a part of said generated four-wave-mixing light is supplied as the incident standard lights.

2. A multi-wavelength light source according to claim 1, wherein said four-wave-mixing means includes a first optical fiber having a zero-dispersion wavelength close to frequencies of said standard lights supplied by said standard light generating means.

3. A multi-wavelength light source according to claim 2, wherein said four-wave-mixing means further includes a second optical fiber whose zero-dispersion wavelength is shifted off the zero-dispersion wavelength of said first optical fiber toward either a larger wavelength side or a shorter wavelength side.

4. A multi-wavelength light source according to claim 1, wherein said standard light generating means comprises a plurality of lasers of different wavelengths.

5. A method of acquiring multi-wavelength lights, comprising the steps of:
launching a plurality of standard lights of different frequencies, the difference between which is predetermined, into a predetermined optical fiber to thereby generate a four-wave-mixing light;
launching a part of said generated four-wave-mixing light into said predetermined optical fiber as a fresh standard light;
repeating a process of generating the four-wave-mixing light from said fresh standard and said standard lights; and
acquiring a plurality of lights of different frequencies from said four-wave-mixing light generated at said repeating step.

6. An acquiring method according to claim 5, wherein coherent lights are used as said plurality of standard lights.

7. An acquiring method according to claim 5, wherein said predetermined optical fiber comprises a first optical fiber having a predetermined zero dispersion wavelength and a second optical fiber having a zero-dispersion wavelength that is shifted off said zero-dispersion wavelength of said first optical fiber toward either a longer wavelength side or a shorter wavelength side.
